(19) United States
(12) Patent Application Publication
(10) Pub. No.: US 2025/0026188 A1
(43) Pub. Date: Jan. 23, 2025

(54) DOOR SUPPORT DEVICE

(71) Applicant: AISIN CORPORATION, Kariya (JP)

(72) Inventor: Seiichi SUMIYA, Kariya-shi (JP)

(73) Assignee: AISIN CORPORATION, Kariya (JP)

(21) Appl. No.: 18/742,487

(22) Filed: Jun. 13, 2024

(30) Foreign Application Priority Data
Jul. 18, 2023 (JP) 2023-116815

(51) Int. Cl. B60J 5/10

(52) U.S. Cl. CPC B60J 5/10

(57) ABSTRACT

There is provided a door support device that can restrict a door from being overhanging greatly from a vehicle body when the door opens or closes a door opening. The door support device includes: a main link with a proximal portion rotatably connected to the vehicle body and a distal portion rotatably connected to the door; a sub-link with a proximal portion rotatably connected to the vehicle body and a distal portion rotatably connected to the door, each of the portions being connected at a position different from a position for the main link; and a door drive unit that drives the door. The main link and the sub-link constitute a four-bar link mechanism together with the vehicle body and the door. The main link includes an adjusting mechanism for adjusting a distance between a connecting portion connected to the vehicle body and a connecting portion connected to the door.

### CROSS REFERENCE TO RELATED APPLICATIONS

This application is based on and claims priority under 35 U.S.C. § 119 to Japanese Patent Application 2023-116815, filed on Jul. 18, 2023, the entire content of which is incorporated herein by reference.

### TECHNICAL FIELD

This disclosure generally relates to a door support device.

### BACKGROUND DISCUSSION

In JP2008-195091A, there is described a vehicle that includes a vehicle body having a door opening, a back door that opens and closes the door opening, and a four-bar link mechanism that connects the vehicle body to the back door. The four-bar link mechanism includes a vehicle-body side bracket to be fixed to the vehicle body, a door side bracket to be fixed to the back door, and two swinging arms that connect the vehicle-body side bracket to the door side bracket. The vehicle as described above reduces an amount of overhang of the back door in a backward direction when the back door is opened or closed compared with a case in which the back door is connected to the vehicle body via a hinge. In other words, even when only a small space is available behind the vehicle, the back door can be opened or closed.

A need thus exists for a door support device, which is not susceptible to the drawback mentioned above.

### SUMMARY

A door support device for solving the problem described above is a door support device that causes a vehicle body having a door opening to support a door that opens and closes the door opening, and includes: a main link with a proximal portion rotatably connected to the vehicle body and a distal portion rotatably connected to the door; a sub-link with a proximal portion rotatably connected to the vehicle body and a distal portion rotatably connected to the door, each of the portions being connected at a position different from the position for the main link; and a door drive unit that applies a load to the door in at least an opening direction of the opening direction and an closing direction of the door, wherein the main link and the sub-link constitute a four-bar link mechanism together with the vehicle body and the door, and the main link includes an adjusting mechanism for adjusting a distance between a connecting portion connected to the vehicle body and a connecting portion connected to the door.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a rear part of a vehicle when a back door is positioned at a fully closed position;

FIG. 2 is a perspective view of the rear part of the vehicle when the back door is positioned at a fully open position;

FIG. 3 is a perspective view of a door support device;

FIG. 4 is an exploded perspective view of the door support device;

FIG. 5 is an exploded perspective view of a main link;

FIG. 6 is an exploded perspective view of the main link;

FIG. 7 is a side view of the rear part of the vehicle when the back door is positioned at the fully closed position;

FIG. 8 is a side view of the rear part of the vehicle when the back door is positioned at an intermediate position;

FIG. 9 is a side view of the rear part of the vehicle when the back door is positioned at the fully open position;

FIG. 10 is a side view of the door support device when the back door is positioned at the fully closed position;

FIG. 11 is a side view of the door support device when the back door is positioned at the intermediate position;

FIG. 12 is a side view of the door support device when the back door is positioned at the fully open position; and

FIG. 13 is a side view of the rear part of the vehicle in a variation example.

### DETAILED DESCRIPTION

An embodiment of a vehicle including a door support device is described below.

### Configuration of the Present Embodiment

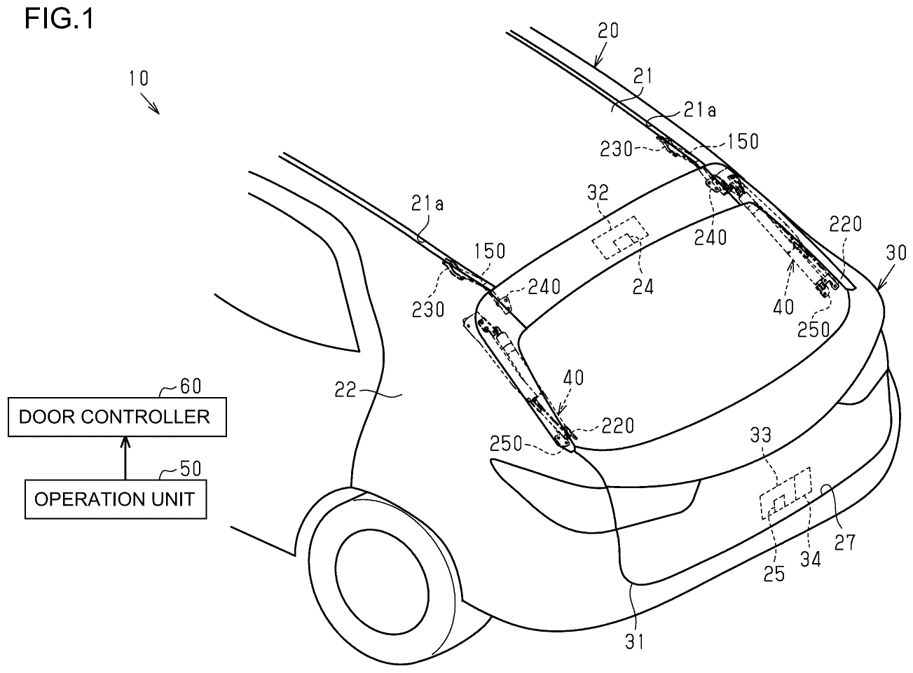

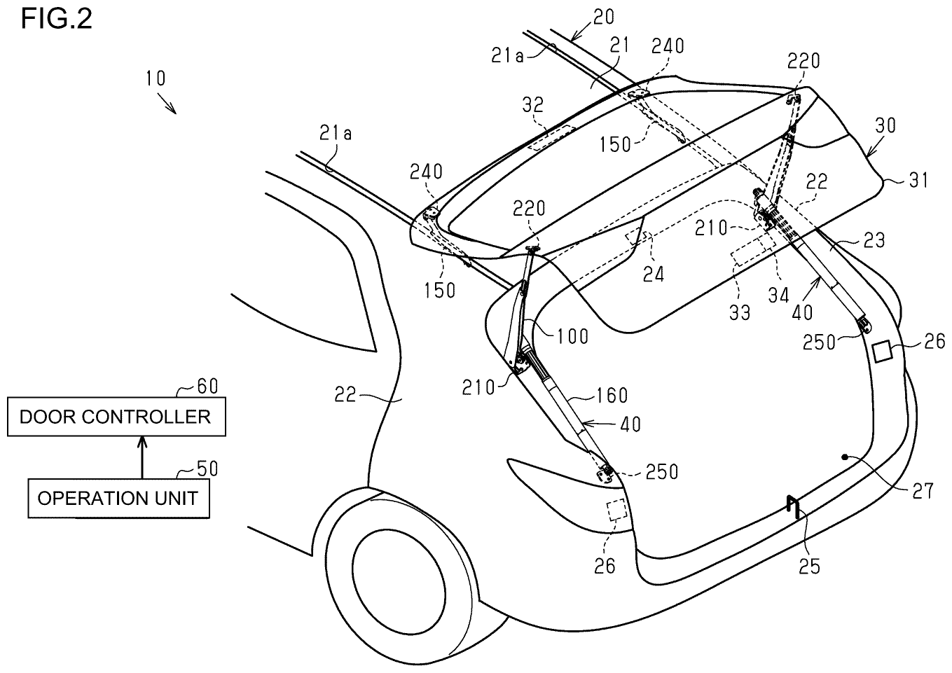

A vehicle 10 includes, as illustrated in FIG. 1 and FIG. 2, a vehicle body 20, a back door 30, two door support devices 40, an operation unit 50, and a door controller 60.

In the present embodiment, the vehicle 10 is a vehicle of a so-called SUV type. In an alternative embodiment, the vehicle 10 may be a minivan, a sedan, or a different type of vehicle as long as the vehicle 10 includes the back door 30. In the description below, a width direction of the vehicle 10 is simply referred to as the width direction, a front-back direction of the vehicle 10 is simply referred to as the front-back direction, and a vertical direction of the vehicle 10 is simply referred to as the vertical direction.

<Vehicle body 20>

As illustrated in FIG. 1 and FIG. 2, the vehicle body 20 includes a roof 21, two rear pillars 22, a trough 23, an upper striker 24 and a lower striker 25, and two elastic members 26. The vehicle body 20 also has a door opening 27.

The roof 21 constitutes a roof portion of the vehicle body 20. The roof 21 is provided with two concave grooves 21a that extend in the front-back direction. The two concave grooves 21a are located on both sides of the roof 21 in the width direction, one for each side. For the concave groove 21a, a downward direction is defined as a depth direction. In the concave groove 21a, a roof molding is usually disposed. This kind of roof 21 provided with the concave grooves 21a may be referred to as a mohawk roof.

The two rear pillars 22 are a part of a frame that constitutes the vehicle body 20. The two rear pillars 22 extend upward in the forward direction on both sides in the width direction. The two rear pillars 22 are connected to the roof 21 on both sides in the width direction at positions nearer a rear end of the roof 21.

The trough 23 is located in such a way as to surround the door opening 27 at an upper end and both ends in the width direction. In other words, the trough 23 defines the door opening 27 in the width direction and from above. Since the trough 23 is a portion through which rainwater or the like flows, the trough 23 is preferably inclined moderately relative to the vertical direction. The trough 23 may be integrally formed with the rear pillars 22.

The upper striker 24 is located near the upper end of the door opening 27 and in the center in the width direction. The lower striker 25 is located near a lower end of the door opening 27 and in the center in the width direction. The upper striker 24 and the lower striker 25 are connecting portions of the vehicle body 20 to which the back door 30 is connected. The upper striker 24 and the lower striker 25 is formed, for example, of a metallic material in a U-shape.

The two elastic members 26 are located on both sides of the trough 23 in the width direction, one for each side. The elastic member 26 is formed of an elastomer such as a rubber or a resin. With the elastic member 26 elastically and compressively deformed by the back door 30, a gap between the vehicle body 20 and the back door 30 is filled by the elastic member 26. The elastic member 26 may have any shape and may be mounted anywhere as long as the elastic member 26 may be elastically compressed by the back door 30. The elastic member 26 may be integrally formed with a weatherstrip, or may be formed separately from the weatherstrip.

### <Back Door 30>

As illustrated in FIG. 1 and FIG. 2, the back door 30 opens and closes the door opening 27. More specifically, the back door 30 is displaced between a fully closed position at which the back door 30 fully closes the door opening 27 as illustrated in FIG. 1 and a fully open position at which the back door 30 fully opens the door opening 27 as illustrated in FIG. 2. In the description below, when the back door 30 is positioned at the fully closed position, a portion that covers the upper end of the door opening 27 is referred to as a proximal portion of the back door 30 while a portion that covers the lower end of the door opening 27 is referred to as a distal portion of the back door 30. In addition, a direction in which the back door 30 moves from the fully closed position toward the fully open position is referred to as an opening direction while a direction in which the back door 30 moves from the fully open position toward the fully closed position is referred to as a closing direction. In addition, a degree of opening of the back door 30 is referred to as an opening degree of the back door 30. The opening degree of the back door 30 is minimum when the back door 30 is positioned at the fully closed position while the opening degree of the back door 30 is maximum when the back door 30 is positioned at the fully open position.

The back door 30 includes a door main unit 31, an upper locking device 32 and a lower locking device 33, and a door-lock drive unit 34. The door main unit 31 has a shape that matches the door opening 27.

The upper locking device 32 is located near a proximal end of the door main unit 31 and in the center in the width direction. The lower locking device 33 is located near a distal end of the door main unit 31 and in the center in the width direction. The upper locking device 32 and the lower locking device 33 are connecting portions of the door main unit 31 to which the vehicle body 20 is connected. When the back door 30 is positioned at the fully closed position, the upper locking device 32 comes into contact with the upper striker 24 and the lower locking device 33 comes into contact with the lower striker 25. The upper locking device 32 is constructed with, for example, a latch that rotates between a fully latched position at which the latch is engageable with the upper striker 24 and an unlatched position at which the latch is not engageable with the upper striker 24. Similarly, the lower locking device 33 is constructed with a latch that is engageable with the lower striker 25.

The door-lock drive unit 34 drives the upper locking device 32 and the lower locking device 33. More specifically, the door-lock drive unit 34 performs a close operation in which the latch of the upper locking device 32 and the latch of the lower locking device 33 are individually rotated toward the fully latched position when the back door 30 is positioned near the fully closed position. In this manner, the door-lock drive unit 34 causes the latch of the upper locking device 32 and the latch of the lower locking device 33 to be respectively engaged with the upper striker 24 and the lower striker 25. When the close operation is complete, the back door 30 is bound by the vehicle body 20 at the fully closed position.

In contrast, the door-lock drive unit 34 performs a release operation in which the latch of the upper locking device 32 and the latch of the lower locking device 33 are individually rotated toward the unlatched position when the back door 30 is opened from the fully closed position. In this manner, the door-lock drive unit 34 releases the latch of the upper locking device 32 from engagement with the upper striker 24 and releases the latch of the lower locking device 33 from engagement with the lower striker 25. When the release operation is complete, the back door 30 may be opened toward the fully open position.

The back door 30 may include two door-lock drive units 34, one of which drives the upper locking device 32 and the other of which drives the lower locking device 33; alternatively, the back door 30 may include a single door-lock drive unit 34 that drives both the upper locking device 32 and the lower locking device 33. In the latter case, the door-lock drive unit 34 is preferably integrally constructed with one of the upper locking device 32 and the lower locking device 33 while the door-lock drive unit 34 is connected through a power transmission member such as a cable to the other one of the upper locking device 32 and the lower locking device 33.

### <Door Support Device 40>

As illustrated in FIG. 1 and FIG. 2, the two door support devices 40 connect the vehicle body 20 to the back door 30 on both sides in the width direction. In other words, the two door support devices 40 cause the vehicle body 20 to support the back door 30. The two door support devices 40 have shapes symmetric with respect to the width direction. Hereinafter, description is made on the door support device 40 on the left in the width direction, and description on the door support device 40 on the right is omitted.

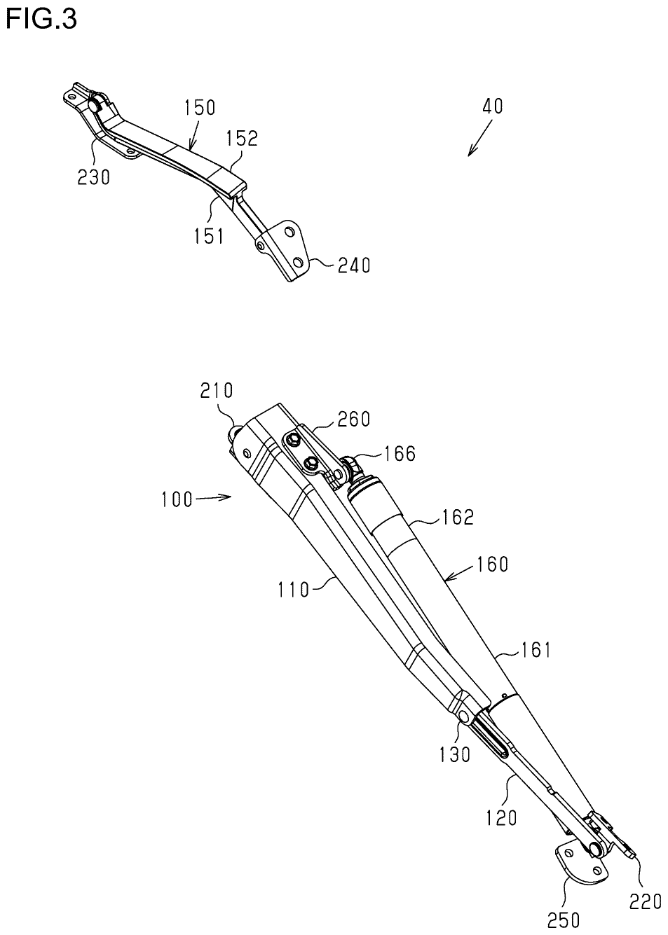

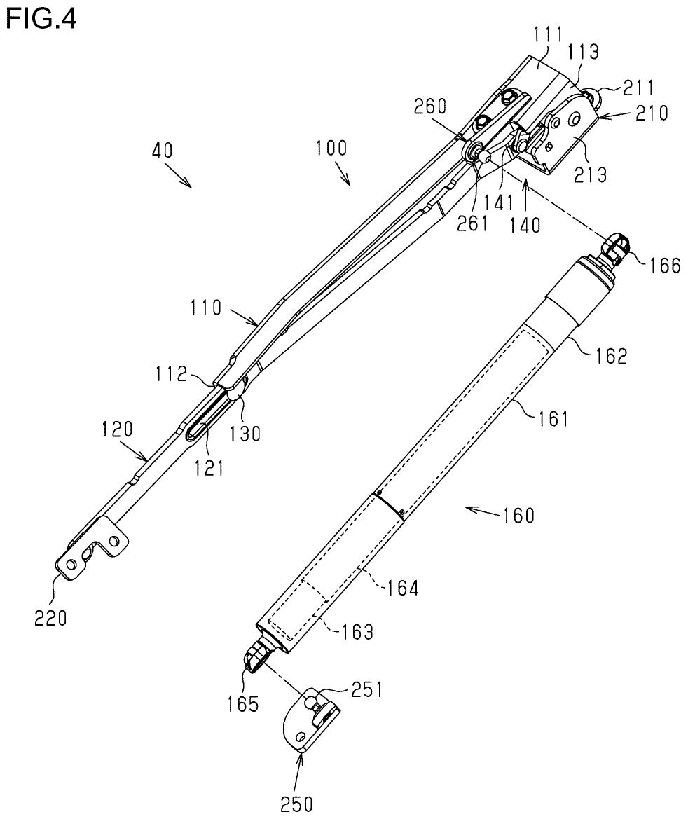

As illustrated in FIG. 3 and FIG. 4, the door support device 40 includes a main link 100, a sub-link 150, and a door drive unit 160. The door support device 40 also includes a vehicle-body side main bracket 210, a door side main bracket 220, a vehicle-body side sub-bracket 230, a door side sub-bracket 240, a first ACT bracket 250, and a second ACT bracket 260.

In the description below, in the main link 100 and the sub-link 150, an end portion connected to the vehicle body 20 is referred to as a proximal portion while an end portion connected to the back door 30 is referred to as a distal portion. In addition, in the door drive unit 160, an end portion connected to the vehicle body 20 is referred to as a proximal portion while an end portion opposite to the proximal portion is referred to as a distal portion.

### <Main Link 100>

As illustrated in FIG. 4, the main link 100 includes a base link 110, a sliding link 120, a guide pin 130, and an adjusting mechanism 140.

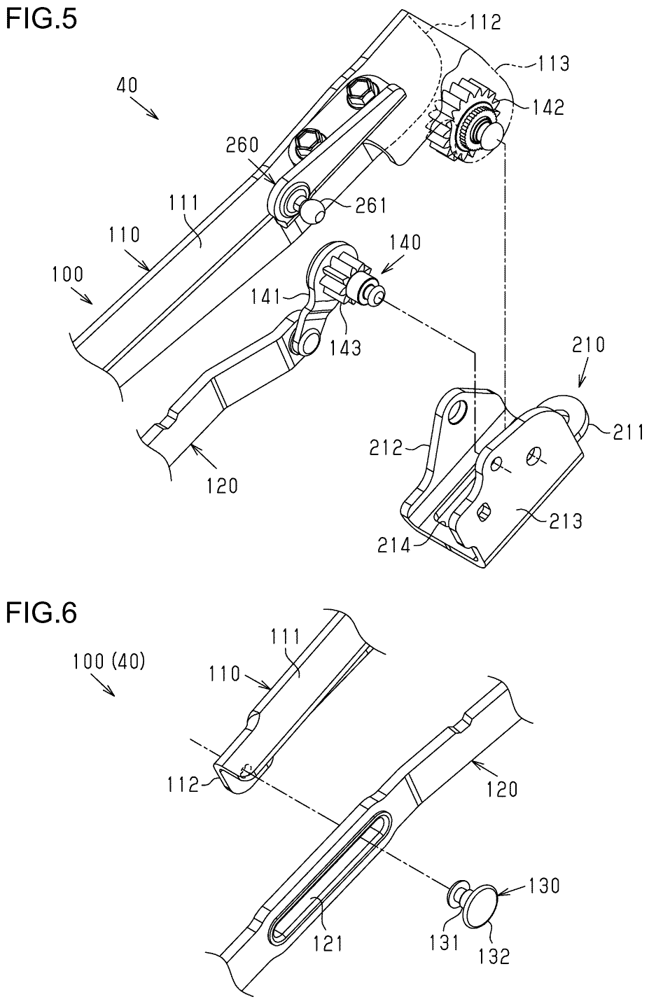

As illustrated in FIG. 4 and FIG. 5, the base link 110 is formed, for example, by stamping a metallic plate. The base link 110 includes an upper wall 111, a first sidewall 112, and a second sidewall 113. The upper wall 111, the first sidewall 112, and the second sidewall 113 are plate-shaped. The first sidewall 112 extends from a first end of the upper wall 111 in the width direction while the second sidewall 113 extends from a second end of the upper wall 111 in the width direction. The length of the first sidewall 112 in a longitudinal direction of the base link 110 is as long as the length of the upper wall 111. In contrast, the length of the second sidewall 113 in the longitudinal direction of the base link 110 is much shorter than the length of the upper wall 111. In this sense, it can be said that the second sidewall 113 extends from the proximal portion of the upper wall 111. For the first sidewall 112 and the second sidewall 113, the width direction is defined as a plate thickness direction. Therefore, the first sidewall 112 and the second sidewall 113 are oppositely positioned in the width direction.

As illustrated in FIG. 4 and FIG. 6, the sliding link 120 is elongated and plate-shaped. The length in a longitudinal direction of the sliding link 120 is much longer than the length in the longitudinal direction of the base link 110. The sliding link 120 is provided with a guide hole 121 that penetrates through in a plate thickness direction. The guide hole 121 is an elongated hole that extends in the longitudinal direction of the sliding link 120. The guide hole 121 is formed in a position nearer to a proximal portion of the sliding link 120 than to a distal portion.

The guide pin 130 includes a shaft 131 and a head 132. The shaft 131 has a cylindrical shape. An outer diameter of the shaft 131 is slightly smaller than a width of the guide hole 121 of the sliding link 120. The head 132 is disk-shaped. An outer diameter of the head 132 is slightly larger than the width of the guide hole 121 of the sliding link 120. The guide pin 130 is inserted in the guide hole 121 of the sliding link 120 and fixed to a distal portion of the base link 110. In this manner, the sliding link 120 is movable relative to the base link 110 and the guide pin 130 in the longitudinal direction of the guide hole 121 and rotatable at the same time about an axis of the guide pin 130. When the sliding link 120 moves or rotates relative to the base link 110, an external surface of the guide pin 130 slides in contact with an inside surface of the guide hole 121 of the sliding link 120.

As illustrated in FIG. 5, the adjusting mechanism 140 includes a driven link 141, a drive gear 142, and a driven gear 143.

The driven link 141 is plate-shaped. The length in a longitudinal direction of the driven link 141 is much shorter than the lengths in the longitudinal directions of the base link 110 and the sliding link 120. A distal portion of the driven link 141 is connected to the proximal portion of the sliding link 120. In this manner, the driven link 141 and the sliding link 120 are rotatable relative to each other about an axis that extends in the width direction.

The drive gear 142 is fixed to the second sidewall 113 of the base link 110. In other words, the drive gear 142 is integrated with the base link 110. As an example, the second sidewall 113 of the base link 110 may be provided with a spline hole and the drive gear 142 may be provided with a splined shaft that matches the spline hole. In this manner, by inserting the splined shaft of the drive gear 142 into the spline hole of the second sidewall 113 of the base link 110, the base link 110 can be integrated with the drive gear 142. The number of teeth of the driven gear 143 is smaller than that of the drive gear 142. A pitch diameter of the driven gear 143 is smaller than that of the drive gear 142. The driven gear 143 is fixed to a proximal portion of the driven link 141. In other words, the driven gear 143 is integrated with the driven link 141. A mode of fixing the driven gear 143 to the driven link 141 may be similar to a mode of fixing the drive gear 142 to the base link 110.

When the driven link 141 rotates, the distal portion of the driven link 141 moves in conjunction with the proximal portion of the sliding link 120. At this time, a movement direction of the sliding link 120 is restricted by the guide pin 130 that passes through the guide hole 121. More specifically, the sliding link 120 swings about the axis of the guide pin 130 and slides at the same time in the longitudinal direction of the base link 110. In this sense, it can be said that the driven link 141 slides the sliding link 120 relative to the base link 110.

### <Main Bracket 210, 220>

As illustrated in FIG. 5, the vehicle-body side main bracket 210 is formed, for example, by stamping a metallic plate. The vehicle-body side main bracket 210 includes a bottom wall 211, a first sidewall 212, and a second sidewall 213. When viewed from a plate thickness direction, the bottom wall 211 has a rectangular shape. The bottom wall 211 is provided with an escape hole 214 that penetrates through in the plate thickness direction. When viewed from the plate thickness direction of the bottom wall 211, the escape hole 214 has a rectangular shape that is slightly smaller than the bottom wall 211. The first sidewall 212 extends from a first end of the bottom wall 211 in the width direction while the second sidewall 213 extends from a second end of the bottom wall 211 in the width direction. For the first sidewall 212 and the second sidewall 213, the width direction is defined as a plate thickness direction. Therefore, the first sidewall 212 and the second sidewall 213 are oppositely positioned in the width direction.

The first sidewall 212 of the vehicle-body side main bracket 210 is connected to the first sidewall 112 of the base link 110 by means of a connecting member such as a rivet. Similarly, the second sidewall 213 of the vehicle-body side main bracket 210 is connected to the second sidewall 113 of the base link 110 and the drive gear 142 by means of a connecting member such as a rivet. In this manner, the base link 110 is rotatable relative to the vehicle-body side main bracket 210 about an axis that extends in the width direction. An axis of rotation of the base link 110 coincides with an axis of rotation of the drive gear 142. Therefore, when the base link 110 rotates, the drive gear 142 rotates about the same axis of rotation as that of the base link 110.

The second sidewall 213 of the vehicle-body side main bracket 210 is connected to the proximal portion of the driven link 141 and the driven gear 143 by means of a connecting member such as a rivet. In this manner, the driven link 141 is rotatable relative to the vehicle-body side main bracket 210 about an axis that extends in the width direction. An axis of rotation of the driven link 141 coincides with an axis of rotation of the driven gear 143. Therefore, when the driven link 141 rotates, the driven gear 143 rotates about the same axis of rotation as that of the driven link 141. Note that the drive gear 142 and the driven gear 143 engage with each other. Therefore, when the drive gear 142 rotates, the driven gear 143 also rotates.

As illustrated in FIG. 2, the vehicle-body side main bracket 210 is fixed to the vehicle body 20 at a position near an upper end of a section of the trough 23 that extends in the vertical direction. As described above, the proximal portion of the main link 100 is rotatably connected to the trough 23 of the vehicle body 20.

As illustrated in FIG. 3, the door side main bracket 220 is connected to the distal portion of the sliding link 120 by means of a connecting member such as a rivet. In this manner, the sliding link 120 is rotatable relative to the door side main bracket 220 about an axis that extends in the width direction. As illustrated in FIG. 1 and FIG. 2, the door side main bracket 220 is fixed to the back door 30 at an intermediate portion between a proximal end and a distal end of the back door 30. As described above, the distal portion of the main link 100 is rotatably connected to the back door 30.

### <Sub-Link 150>

As illustrated in FIG. 3, the sub-link 150 is rod-shaped. A cross-sectional shape perpendicular to a longitudinal direction of the sub-link 150 is T-shaped. The sub-link 150 includes a main section 151 and a covering section 152. The main section 151 is plate-shaped with the width direction being a plate thickness direction. The covering section 152 is plate-shaped with a direction perpendicular to the width direction being a plate thickness direction. A width of the covering section 152 is slightly smaller than a width of the concave groove 21a of the roof 21.

### <Sub-Bracket 230, 240>

The vehicle-body side sub-bracket 230 is connected to a proximal portion of the sub-link 150 by means of a connecting member such as a rivet. In this manner, the sub-link 150 is rotatable relative to the vehicle-body side sub-bracket 230 about an axis that extends in the width direction. As illustrated in FIG. 1, the vehicle-body side sub-bracket 230 is fixed to the vehicle body 20 at a position near a rear end of the roof 21. More specifically, the vehicle-body side sub-bracket 230 is fixed to an underside of the roof 21 that constitutes the concave groove 21a. Therefore, the vehicle-body side sub-bracket 230 is not easily noticeable in an external appearance of the roof 21. In addition, the vehicle-body side sub-bracket 230 is positioned ahead of and above the vehicle-body side main bracket 210. As described above, the proximal portion of the sub-link 150 is rotatably connected to the roof 21 of the vehicle body 20.

As illustrated in FIG. 1 and FIG. 2, the door side sub-bracket 240 is connected to a distal portion of the sub-link 150 by means of a connecting member such as a rivet. In this manner, the sub-link 150 is rotatable relative to the door side sub-bracket 240 about an axis that extends in the width direction. The door side sub-bracket 240 is fixed to the back door 30 at a position near a proximal end of the back door 30. As described above, the distal portion of the sub-link 150 is rotatably connected to the back door 30 at a position different from the position for the distal portion of the main link 100.

### <Door Drive Unit 160>

As illustrated in FIG. 4, the door drive unit 160 is rod-shaped. The door drive unit 160 includes an outer cylinder 161, an inner cylinder 162, an electric motor 163, a conversion mechanism 164, a first ball socket 165, and a second ball socket 166.

The outer cylinder 161 and the inner cylinder 162 each have a cylindrical shape. An inner diameter of the outer cylinder 161 is slightly larger than an outer diameter of the inner cylinder 162. The inner cylinder 162 is inserted into the outer cylinder 161 with axial directions aligned with each other. The inner cylinder 162 is axially movable relative to the outer cylinder 161. The electric motor 163 is housed in the outer cylinder 161. The electric motor 163 is powered via an unillustrated harness. The conversion mechanism 164 is housed inside across the inner cylinder 162 and the outer cylinder 161. The conversion mechanism 164 is a mechanism for converting rotation movement of an output shaft of the electric motor 163 into linear movement of the inner cylinder 162 relative to the outer cylinder 161. As an example, the conversion mechanism 164 may be a lead screw mechanism.

The first ball socket 165 is fixed to an end of opposite ends in a longitudinal direction of the outer cylinder 161, into which the inner cylinder 162 is not inserted. The second ball socket 166 is fixed to the other end of the opposite ends in a longitudinal direction of the inner cylinder 162, the end not being inserted into the outer cylinder 161. In other words, the first ball socket 165 and the second ball socket 166 constitute opposite ends in a longitudinal direction of the door drive unit 160.

### <ACT Bracket 250, 260>

As illustrated in FIG. 4, the first ACT bracket 250 includes a first ball stud 251. As illustrated in FIG. 2, the first ACT bracket 250 is fixed to the vehicle body 20 at a position near a lower end of the section of the trough 23 that extends in the vertical direction. The first ball stud 251 is put into the first ball socket 165 of the door drive unit 160. The first ball stud 251 of the first ACT bracket 250 and the first ball socket 165 of the door drive unit 160 constitute a ball joint. In this manner, a proximal portion of the door drive unit 160 is rotatably connected to the vehicle body 20.

As illustrated in FIG. 4, the second ACT bracket 260 includes a second ball stud 261. The second ACT bracket 260 is fixed to the main link 100. More specifically, the second ACT bracket 260 is fixed to the proximal portion of the upper wall 111 of the base link 110. The second ball stud 261 is put into the second ball socket 166 of the door drive unit 160. The second ball stud 261 of the second ACT bracket 260 and the second ball socket 166 of the door drive unit 160 constitute a ball joint. In this manner, a distal portion of the door drive unit 160 is rotatably connected to the base link 110 of the main link 100.

### <Link Mechanism>

As described above, in the present embodiment, the vehicle body 20, the back door 30, the main link 100, and the sub-link 150 constitute a so-called four-bar link mechanism. In addition, the base link 110, the sliding link 120, the driven link 141, the drive gear 142 and the driven gear 143, and the guide pin 130 constitute a slider mechanism for converting rotation movement of the base link 110 into forward and backward movement of the sliding link 120.

### <Operation Unit 50>

The operation unit 50 is a unit operated by a user when the user wants to actuate the back door 30. The operation unit 50 may be provided around a driver's seat in the vehicle 10, on the back door 30, or in a mobile device such as an electronic key or a smartphone. The operation unit 50 outputs a signal to the door controller 60 when operated by the user. The signals output by the operation unit 50 to the door controller 60 include, for example, an open command signal for opening the back door 30, a close command signal for closing the back door 30, and a stop command signal for stopping the back door 30 that is in motion.

### <Door Controller 60>

The door controller 60 is an electronic controller including a CPU and a memory. In the door controller 60, the CPU executes a program stored in the memory to control operation of the back door 30. The door controller 60 is connected to the operation unit 50 by a wired or wireless connection. In addition, the door controller 60 is connected to the door-lock drive unit 34 and the door drive unit 160 via an in-vehicle network.

When the open command signal is input to the door controller 60, the door controller 60 controls the door drive unit 160 to extend the door drive unit 160. In this manner, the door controller 60 causes the back door 30 to open toward the fully open position. When the open command signal is input to the door controller 60 under a condition where the back door 30 is positioned at the fully closed position, the door controller 60 controls the door-lock drive unit 34 before controlling the door drive unit 160. More specifically, the door controller 60 controls the door-lock drive unit 34 to cause the door-lock drive unit 34 to perform a release operation. In this manner, the door controller 60 causes the upper locking device 32 and the lower locking device 33 to release the back door 30 that has been bound by these locking devices.

In contrast, when the close command signal is input to the door controller 60, the door controller 60 controls the door drive unit 160 to shrink the door drive unit 160. In this manner, the door controller 60 causes the back door 30 to close toward the fully closed position. After the back door 30 is closed to a position near the fully closed position, the door controller 60 controls the door-lock drive unit 34 to cause the door-lock drive unit 34 to perform a close operation. In this manner, the door controller 60 causes the back door 30 to draw to the fully closed position and to be bound by the vehicle body 20.

When the stop command signal is input to the door controller 60 while the back door 30 is opening or closing, the door controller 60 causes the door drive unit 160 to stop extending or shrinking. In this manner, the door controller 60 causes the back door 30 to stop.

The vehicle 10 may include a touch sensor for determining whether an object is in contact with the back door 30 while the back door 30 is opening or closing. In this case, the touch sensor is preferably mounted along an edge of the back door 30. When the touch sensor detects that an object is in contact with the back door while the back door 30 is opening or closing, the door controller 60 preferably causes the back door 30 to stop or to move in the reverse direction.

### Operation in the Present Embodiment

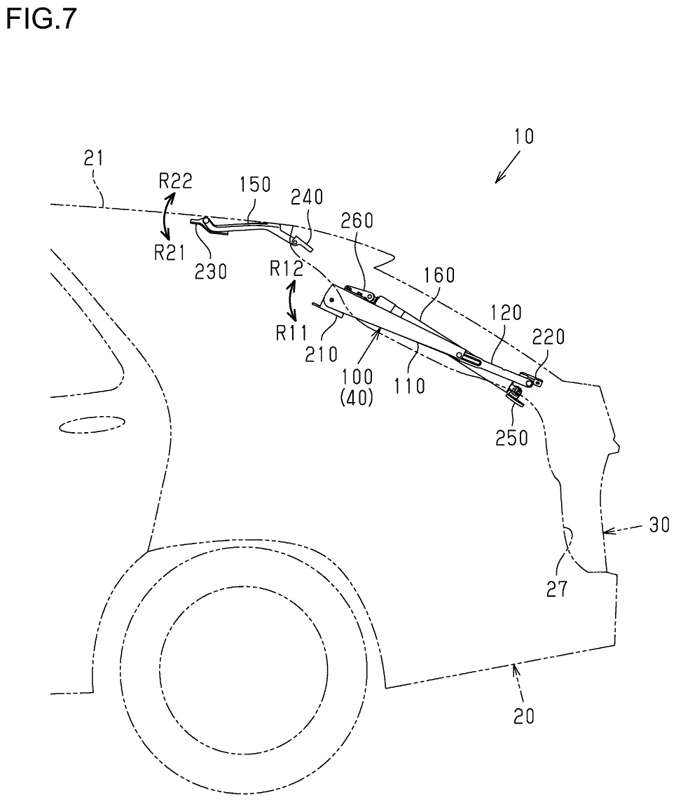

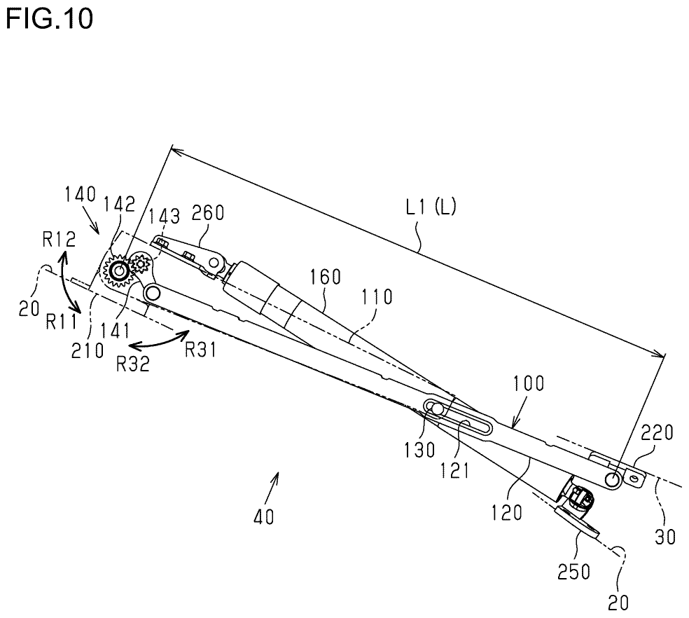

With reference to FIGS. 7 to 12, an operation of the door support device 40 when the back door 30 is opened is described. FIGS. 7 to 9 illustrate variation in states of a rear part of the vehicle 10, and FIGS. 10 to 12 illustrate variation in states of the door support device 40.

FIGS. 7 and 10 illustrate the states in which the back door 30 is positioned at the fully closed position. When the back door 30 is positioned at the fully closed position, the door drive unit 160 is in a fully shrunk state. The main link 100 is in the most rotated state relative to the vehicle-body side main bracket 210 in a second rotation direction R12 while the sub-link 150 is in the most rotated state relative to the vehicle-body side sub-bracket 230 in a second rotation direction R22.

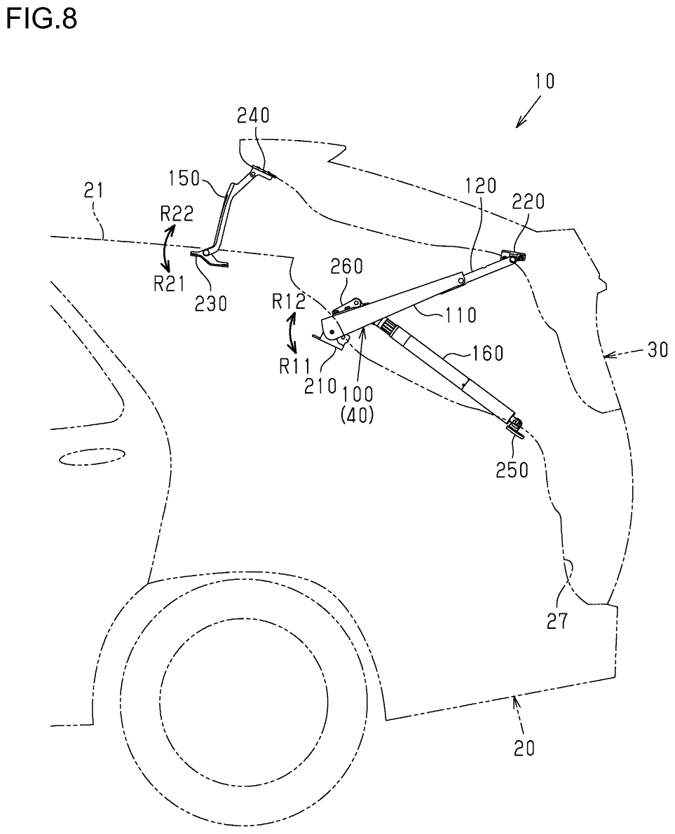

When the back door 30 is opened, the door drive unit 160 extends. As the door drive unit 160 extends, the main link 100 is applied with a torque that causes the main link 100 to rotate relative to the vehicle-body side main bracket 210 in a first rotation direction R11. In other words, the door drive unit 160 applies a load to the back door 30 in the opening direction via the main link 100. When the main link 100 is rotated relative to the vehicle-body side main bracket 210 in the first rotation direction R11, the sub-link 150 is rotated relative to the vehicle-body side sub-bracket 230 in a first rotation direction R21. As a result, as illustrated in FIG. 7 and FIG. 8, the door side main bracket 220 moves forward and upward, and the door side sub-bracket 240 moves forward and upward. In this manner, the back door 30 moves upward and forward.

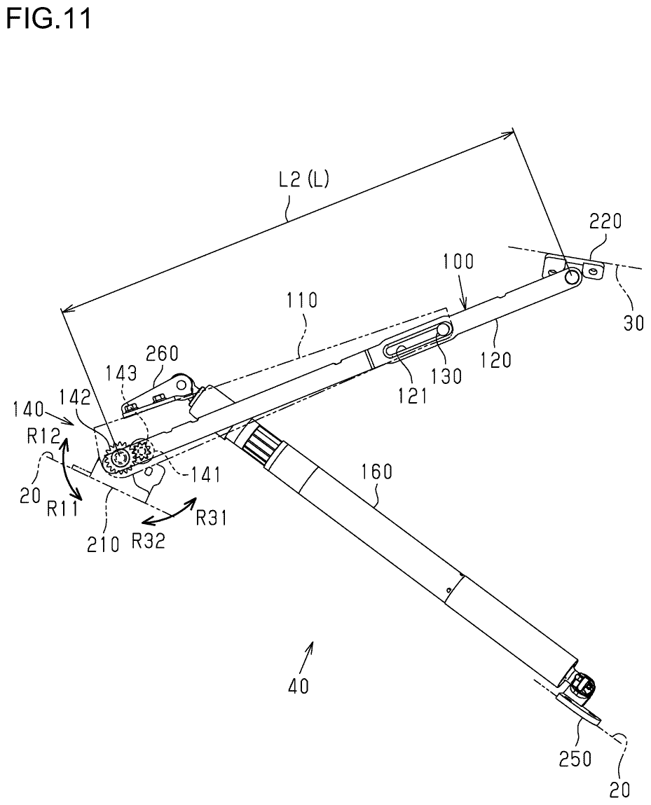

As illustrated in FIG. 10 and FIG. 11, when the door drive unit 160 extends under a condition where the back door 30 is positioned at the fully closed position, the main link 100 is rotated in conjunction with the drive gear 142 relative to the vehicle-body side main bracket 210 in the first rotation direction R11. Therefore, the driven gear 143 engaging with the drive gear 142 is rotated in conjunction with the driven link 141 in a second rotation direction R32. As a result, the proximal portion of the sliding link 120 connected to the driven link 141 is pulled toward a proximal end of the base link 110. It is to be noted here that, in the guide hole 121 of the sliding link 120, the guide pin 130 fixed to the base link 110 is inserted. The sliding link 120 is therefore displaced while being guided by the guide pin 130, which reduces a length of protrusion of the sliding link 120 relative to the base link 110.

Thus, a distance between a connecting portion of the base link 110 connected to the vehicle body 20 and a connecting portion of the sliding link 120 connected to the back door 30 (hereinafter also referred to as a “length L of the main link 100”) becomes shorter from a first length L1. In other words, as the opening degree of the back door 30 changes, the length L of the main link 100 is adjusted by the adjusting mechanism 140.

Note that the vehicle-body side main bracket 210, which is the connecting portion between the main link 100 and the vehicle body 20, is not movable while the door side main bracket 220, which is the connecting portion between the main link 100 and the back door 30, can move in conjunction with the back door 30. Therefore, when the length L of the main link 100 becomes shorter, the door side main bracket 220 will move closer to the vehicle-body side main bracket 210. In other words, compared with a case in which the length L of the main link 100 does not change, the back door 30 is opened in such a way that the back door 30 does not move away from the door opening 27.

FIG. 8 and FIG. 11 illustrate the states in which the back door 30 is positioned at an intermediate position between the fully closed position and the fully open position. When the back door 30 is positioned at the intermediate position between the fully closed position and the fully open position, the length L of the main link 100 is a second length L2, which is the shortest length. In other words, when the back door 30 is operated between the fully closed position and the intermediate position, as the opening degree of the back door 30 is larger, the length L of the main link 100 becomes shorter. In addition, as illustrated in FIG. 11, when viewed from the width direction, a center of rotation of the base link 110 relative to the vehicle-body side main bracket 210, a center of rotation of the sliding link 120 relative to the vehicle-body side main bracket 210, and a center of rotation of the sliding link 120 relative to the door side main bracket 220 are aligned in a straight line.

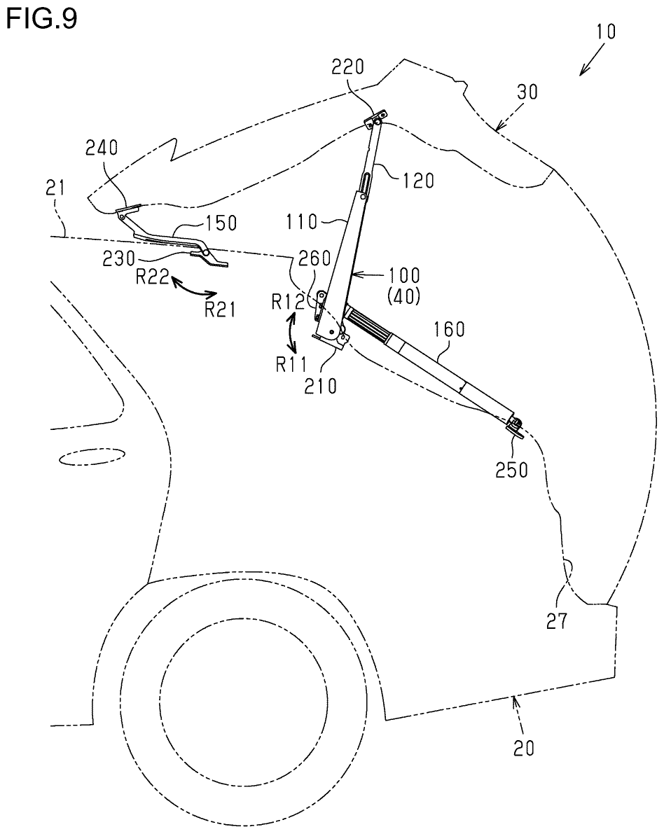

When the door drive unit 160 continues to be extended after the back door 30 reaches the intermediate position, the main link 100 is further rotated relative to the vehicle-body side main bracket 210 in the first rotation direction R11. In other words, the sub-link 150 is also further rotated relative to the vehicle-body side sub-bracket 230 in the first rotation direction R21. As a result, as illustrated in FIG. 8 and FIG. 9, the door side main bracket 220 moves forward and upward, and the door side sub-bracket 240 moves forward and downward. In this manner, the back door 30 moves upward and forward.

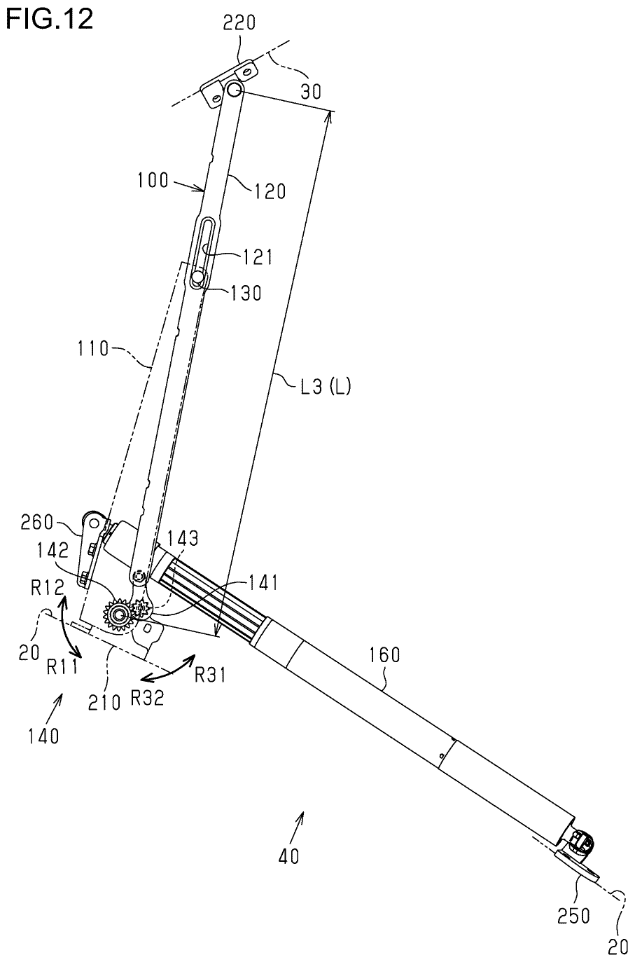

As illustrated in FIG. 11 and FIG. 12, when the door drive unit 160 extends under a condition where the back door 30 is positioned at the intermediate position, the main link 100 is rotated in conjunction with the drive gear 142 relative to the vehicle-body side main bracket 210 in the first rotation direction R11. Therefore, the driven gear 143 engaging with the drive gear 142 is rotated in conjunction with the driven link 141 in the second rotation direction R32. As a result, the proximal portion of the sliding link 120 connected to the driven link 141 is pushed toward a distal end of the base link 110. It is to be noted here that, in the guide hole 121 of the sliding link 120, the guide pin 130 fixed to the base link 110 is inserted. The sliding link 120 is therefore displaced while being guided by the guide pin 130, which increases the length of protrusion of the sliding link 120 relative to the base link 110. In other words, the length L of the main link 100 is increased from the second length L2. When the length L of the main link 100 is increased, the door side main bracket 220 will move farther from the vehicle-body side main bracket 210. In other words, compared with the case in which the length L of the main link 100 does not change, the back door 30 is opened in such a way that the back door 30 moves away from the door opening 27.

FIG. 9 and FIG. 12 illustrate the states in which the back door 30 is positioned at the fully open position. When the back door 30 is positioned at the fully open position, the door drive unit 160 is in a fully extended state. In addition, the length L of the main link 100 becomes the longest as is the case in which the back door 30 is positioned at the fully closed position. More specifically, the length L of the main link 100 is a third length L3, which is as long as the first length L1. In other words, when the back door 30 is operated between the intermediate position and the fully open position, as the opening degree of the back door 30 is larger, the length L of the main link 100 becomes longer.

Next, an operation of the door support device 40 when the back door 30 is closed is briefly described.

When the back door 30 is closed from the fully open position, the door drive unit 160 is shrunk. As the door drive unit 160 is shrunk, the main link 100 is applied with a torque that causes the main link 100 to rotate in the second rotation direction R12. In other words, the door drive unit 160 applies a load to the back door 30 in the closing direction via the main link 100. When the main link 100 is rotated relative to the vehicle-body side main bracket 210 in the second rotation direction R12, the sub-link 150 is rotated relative to the vehicle-body side sub-bracket 230 in the second rotation direction R22. As a result, the door side main bracket 220 moves backward and downward, and the door side sub-bracket 240 moves backward and downward. In this manner, the back door 30 moves backward and downward toward the fully closed position. In addition, when the main link 100 is rotated in the second rotation direction R12, the driven link 141 is rotated in a first rotation direction R31. Therefore, the length L of the main link 100 becomes shorter when the back door 30 moves from the fully open position toward the intermediate position while the length L becomes longer when the back door 30 moves from the intermediate position toward the fully closed position.

### Advantageous Effects of the Present Embodiment

(1) The adjusting mechanism 140 of the door support device 40 can adjust the length L of the main link 100 according to the opening degree of the back door 30. Therefore, the door support device 40 can restrict the back door 30 from being overhanging greatly from the vehicle body 20 when the back door 30 opens or closes the door opening 27.

(2) More specifically, when the back door 30 is opened from the fully closed position toward the intermediate position, the length L of the main link 100 becomes shorter. Therefore, compared with a case in which the length L of the main link 100 does not become shorter, the amount of overhang of the back door 30 in the backward direction is reduced when the back door 30 is opened from the fully closed position.

(3) In addition, when the back door 30 is opened from the intermediate position toward the fully open position, the length L of the main link 100 becomes longer. Therefore, compared with a case in which the length L of the main link 100 does not become longer, the distal end of the back door 30 reaches an even higher position when the back door 30 is positioned at the fully open position. Thus, the door support device 40 can expose the door opening 27 wide open in the vertical direction when the back door 30 is positioned at the fully open position.

(4) The main link 100 is constructed with the base link 110, the sliding link 120, the drive gear 142, and the driven gear 143. Therefore, the main link 100 can adjust the length of protrusion of the sliding link 120 relative to the base link 110 in conjunction with the rotation of the base link 110 associated with opening or closing the back door 30. Thus, the door support device 40 can appropriately adjust the length L of the main link 100 according to the opening degree of the back door 30 even without a drive source such as an electric motor.

(5) A comparative example is considered here in which one end and the other end of the door drive unit 160 are respectively connected to the vehicle body 20 and the back door 30. In this comparative example, it is necessary to employ a door drive unit that can extend to a very long length because the back door 30 moves even farther from the vehicle body 20 when the back door 30 is positioned at the fully closed position. In contrast to this, in the present embodiment, one end and the other end of the door drive unit 160 are respectively connected to the vehicle body 20 and the main link 100. Therefore, the door drive unit 160 to be employed for the door support device 40 is not required to be extendable to a very long length.

(6) The proximal portion of the sub-link 150 is rotatably connected to the roof 21 of the vehicle body 20. Therefore, compared with a case in which the proximal portion of the sub-link 150 is rotatably connected to the trough 23 of the vehicle body 20, the fully open position of the back door 30 is located further forward and higher.

(7) When the length L of the main link 100 is changed, the external surface of the guide pin 130 slides in contact with the inside surface of the guide hole 121 of the sliding link 120. Therefore, the door support device 40 can reduce friction against sliding when the length L of the main link 100 is changed.

(8) A comparative example is considered here in which the proximal portion of the back door 30 is rotatably supported by the vehicle body 20 about an axis that extends in the width direction. Compared to this comparative example, in the door support device 40 according to the present embodiment, the back door 30 is more easily movable relative to the vehicle body 20 when the back door 30 is positioned at the fully closed position because the back door 30 can move in a direction intersecting with the width direction. With respect to this, in the door support device 40 according to the present embodiment, when the back door 30 is positioned at the fully closed position, the upper locking device 32 and the lower locking device 33 of the back door 30 respectively engage with the upper striker 24 and the lower striker 25 of the vehicle body 20. In other words, the two door-lock devices of the back door 30 individually engage with the associated one of the two strikers of the vehicle body 20. Thus, the door support device 40 can restrict the back door 30 from moving unexpectedly relative to the vehicle body 20 even when vibration generated while the vehicle 10 is traveling is exerted on the back door 30, or when a strong wind is applied to the back door 30.

The vehicle 10 also includes an elastic member 26 that elastically and compressively deforms between the vehicle body 20 and the back door 30 positioned at the fully closed position. Therefore, the back door 30 positioned at the fully closed position is not easily movable relative to the vehicle body 20. Thus, the vehicle 10 can restrict the back door 30 from moving unexpectedly relative to the vehicle body 20 when the back door 30 is positioned at the fully closed position.

(9) The sub-link 150 includes a covering section 152 having a width comparable to that of the concave groove 21a of the roof 21. Therefore, when the back door 30 is positioned at the fully closed position, the main section 151 of the sub-link 150 is housed in the concave groove 21a of the roof 21 and the covering section 152 of the sub-link 150 covers an opening of the concave groove 21a of the roof 21. Thus, the door support device 40 can prevent the external appearance of the roof 21 from being inferior when the back door 30 is positioned at the fully closed position.

(10) The bottom wall 211 of the vehicle-body side main bracket 210 is provided with an escape hole 214. Therefore, when the back door 30 is opened or closed, the sliding link 120 and the driven link 141 may be prevented from coming into conflict with the bottom wall 211 of the vehicle-body side main bracket 210. In other words, the door support device 40 enables the proximal portion of the main link 100 to be small while preventing the sliding link 120 and the driven link 141 from coming into conflict with the vehicle-body side main bracket 210.

### Variation Examples

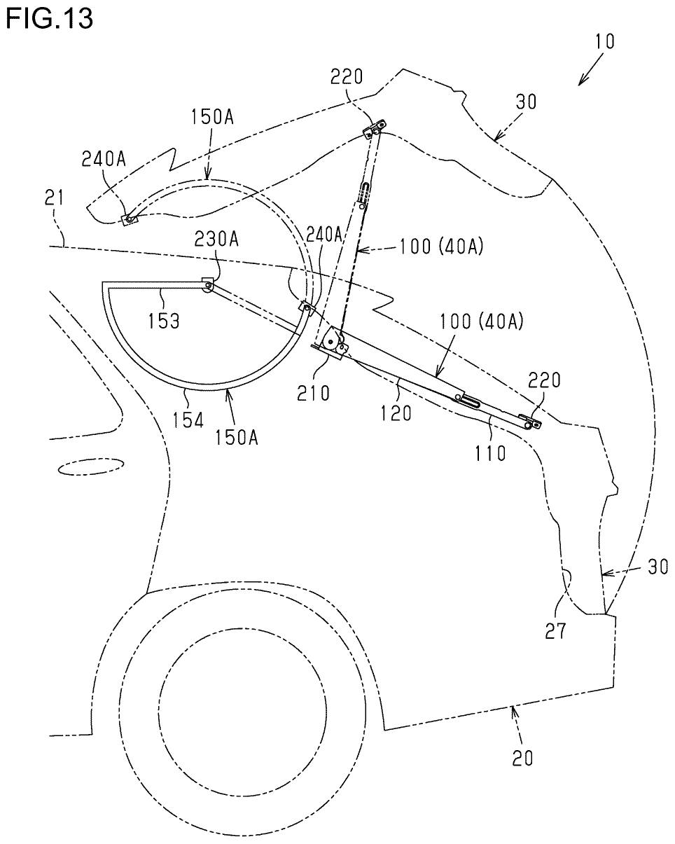

The present embodiment may be modified and implemented as follows. The present embodiment and the following variation examples may be implemented in combination as long as they are technically consistent.
The door support device 40 may be changed to the door support device 40A illustrated in FIG. 13. When compared with the door support device 40 according to the embodiment describe above, the door support device 40A in a variation example is different in the configuration of the sub-link 150. Therefore, in the description below, components of the variation example that are common to the embodiment described above are assigned with the same reference signs and descriptions thereof are omitted. Note that some of the components such as the door drive unit 160 are omitted in FIG. 13 in order to mainly describe differences from the embodiment described above.

As illustrated in FIG. 13, the door support device 40A includes a sub-link 150A as a component that makes a difference in the configuration from the embodiment described above. The sub-link 150A includes a straight section 153 that extends linearly and an arc-shaped section 154 that extends in an arc-like manner from a distal end of the straight section 153. A proximal portion of the straight section 153 of the sub-link 150A is rotatably connected to the vehicle-body side sub-bracket 230A. The vehicle-body side sub-bracket 230A is fixed at a position near the door opening 27 on a surface of the roof 21 facing a vehicle interior. In other words, the sub-link 150A is located in the vehicle interior of the vehicle 10. In this case, for the straight section 153 of the sub-link 150A, a front-back direction is defined as a longitudinal direction. A distal portion of the arc-shaped section 154 of the sub-link 150A is rotatably connected to the door side sub-bracket 240A.

When the back door 30 is opened from the fully closed position, the sub-link 150A protrudes outside the vehicle 10 through the door opening 27. In this case, the door side sub-bracket 240A moves, when viewed from the width direction, forward and upward while tracing an arc. Therefore, although the shape of the sub-link 150A is different, the back door 30 opens on a trajectory similar to that of the embodiment described above.
The main link 100 may be configured to continue shrinking when the back door 30 opens from the fully closed position toward the fully open position. This variation example can achieve the effect (2) of the embodiment described above more evidently.
The main link 100 may be configured to continue extending when the back door 30 opens from the fully closed position toward the fully open position. This variation example can achieve the effect (3) of the embodiment described above more evidently.
In the main link 100, the guide hole 121 of the sliding link 120 and the guide pin 130 are elements for moving the sliding link 120 forward and backward in the longitudinal direction of the base link 110 when the driven link 141 is rotating. Therefore, as long as the function described above is achieved, the guide hole 121 of the sliding link 120 and the guide pin 130 may be omitted in the main link 100. For example, the base link 110 may include a sheath-like member into which the sliding link 120 is inserted.
The base link 110 may be rotatably connected to the back door 30. In this case, the sliding link 120 is preferably rotatably connected to the vehicle body 20.
The length L of the main link 100 may be unchangeable. This variation example enables the amount of overhang of the back door 30 in the backward direction when the back door 30 is opened or closed to be reduced.
Locations of the upper striker 24 and the lower striker 25 may be appropriately changed. For example, the upper striker 24 and the lower striker 25 may be replaced with two side-strikers mounted on both sides of the trough 23 in the width direction. In this case, it is assumed that locations of the upper locking device 32 and the lower locking device 33 of the back door 30 are also changed.
One end and the other end of the door drive unit 160 may be respectively connected to the back door 30 and the main link 100. One end and the other end of the door drive unit 160 may be respectively connected to the vehicle body 20 and the sub-link 150. One end and the other end of the door drive unit 160 may be respectively connected to the back door 30 and the sub-link 150. One end and the other end of the door drive unit 160 may be respectively connected to the vehicle body 20 and the back door 30.
The door drive unit 160 may apply a torque to an axis of rotation of the main link 100 relative to the vehicle-body side main bracket 210. For example, the door drive unit 160 may drive the drive gear 142.
The door drive unit 160 just has to be configured in such a way that the door drive unit 160 can apply a load to the back door 30 in at least one direction of the opening direction and the closing direction of the back door 30, the at least one direction being the opening direction. Specifically, the door drive unit 160 may be replaced with a gas spring. In this case, in the vehicle 10, a component for controlling the door drive unit 160 may be omitted.
The vehicle 10 may be an autonomous driving vehicle without a driver's seat. In this case, the vehicle body 20 may include a front opening that opens in the forward direction and a rear opening that opens in the backward direction. In addition, the vehicle 10 may include a front door that opens and closes the front opening and a back door that opens and closes the rear opening. The door support device 40 may be employed for causing the vehicle body 20 to support the front door and the back door.

### Technical Idea

A technical idea that can be derived from the embodiment described above and the variation examples is described.

[Aspect 1] A door support device that causes a vehicle body having a door opening to support a door that opens and closes the door opening, including: a main link with a proximal portion rotatably connected to the vehicle body and a distal portion rotatably connected to the door; a sub-link with a proximal portion rotatably connected to the vehicle body and a distal portion rotatably connected to the door, each portion being connected at a position different from the position for the main link; a door drive unit that applies a load to the door in at least one direction of directions for opening or closing the door, the at least one direction being the direction for opening the door, wherein the main link and the sub-link constitute a four-bar link mechanism together with the vehicle body and the door, and the main link includes an adjusting mechanism for adjusting a distance between a connecting portion connected to the vehicle body and a connecting portion connected to the door.

[Aspect 2] A door support device according to aspect 1, wherein the main link includes a base link rotatably connected to one of the vehicle body and the door, a sliding link rotatably connected to the other one of the vehicle body and the door, and the adjusting mechanism includes a drive gear that rotates in conjunction with the base link, a driven gear that engages with the drive gear, and a driven link with a proximal portion to which the driven gear is fixed and a distal portion connected to the sliding link in a relatively rotatable manner, and the driven link rotates in conjunction with the driven gear and slides the sliding link relative to the base link.

[Aspect 3] A door support device according to aspect 1 or 2, wherein the door drive unit is rod-shaped and extends to apply a load on the door in the opening direction, and a proximal portion of the door drive unit is rotatably connected to the vehicle body and a distal portion of the door drive unit is rotatably connected to the main link.

[Aspect 4] A door support device according to any one of aspects 1 to 3, wherein the proximal portion of the main link is rotatably connected to a trough of the vehicle body that defines the door opening in the width direction, and the proximal portion of the sub-link is rotatably connected to the roof of the vehicle body.

[Aspect 5] A door support device according to aspect 2, wherein the sliding link is provided with a guide hole that extends in a longitudinal direction of the sliding link, the main link includes a guide pin passing through the guide hole and fixed to the base link, and the sliding link slides in contact with the guide pin via the guide hole when the driven link rotates.

[Aspect 6] A door support device according to any one of aspects 1 to 5, wherein, when a position of the door at which the door opening is fully closed is defined as a fully closed position and a position of the door at which the door opening is fully opened is defined as a fully open position, the adjusting mechanism causes the distance to be shorter as an opening degree of the door is larger when the door is displaced from the fully closed position toward the fully open position.

[Aspect 7] A door support device according to aspect 6, wherein, when a position of the door between the fully closed position and the fully open position is defined as an intermediate position, the adjusting mechanism causes the distance to be shorter as the opening degree of the door is larger when the door is displaced between the fully closed position and the intermediate position and the adjusting mechanism causes the distance to be longer as the opening degree of the door is larger when the door is displaced between the intermediate position and the fully open position.

A door support device for solving the problem described above is a door support device that causes a vehicle body having a door opening to support a door that opens and closes the door opening, and includes: a main link with a proximal portion rotatably connected to the vehicle body and a distal portion rotatably connected to the door; a sub-link with a proximal portion rotatably connected to the vehicle body and a distal portion rotatably connected to the door, each of the portions being connected at a position different from the position for the main link; and a door drive unit that applies a load to the door in at least an opening direction of the opening direction and an closing direction of the door, wherein the main link and the sub-link constitute a four-bar link mechanism together with the vehicle body and the door, and the main link includes an adjusting mechanism for adjusting a distance between a connecting portion connected to the vehicle body and a connecting portion connected to the door.

The door support device can restrict the door from being overhanging greatly from the vehicle body when the door opens or closes the door opening.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door support device that causes a vehicle body having a door opening to support a door that opens and closes the door opening, the door support device comprising:
a main link with a proximal portion rotatably connected to the vehicle body and a distal portion rotatably connected to the door;
a sub-link with a proximal portion rotatably connected to the vehicle body and a distal portion rotatably connected to the door, each of the portions being connected at a position different from a position for the main link; and
a door drive unit that applies a load to the door in at least an opening direction of the opening direction and a closing direction of the door, wherein
the main link and the sub-link constitute a four-bar link mechanism together with the vehicle body and the door, and
the main link includes an adjusting mechanism for adjusting a distance between a connecting portion connected to the vehicle body and a connecting portion connected to the door.

2. The door support device according to claim 1, wherein
the main link includes a base link rotatably connected to one of the vehicle body and the door, and a sliding link rotatably connected to another of the vehicle body and the door,
the adjusting mechanism includes a drive gear that rotates in conjunction with the base link, a driven gear that engages with the drive gear, and a driven link with a proximal portion to which the driven gear is fixed and a distal portion connected to the sliding link in a relatively rotatable manner, and
the driven link rotates in conjunction with the driven gear and thus causes the sliding link to slide relative to the base link.

3. The door support device according to claim 1, wherein
the door drive unit is rod-shaped and extends and applies a load to the door in the opening direction, and
a proximal portion of the door drive unit is rotatably connected to the vehicle body and a distal portion of the door drive unit is rotatably connected to the main link.

4. The door support device according to claim 2, wherein
the door drive unit is rod-shaped and extends and applies a load to the door in the opening direction, and
a proximal portion of the door drive unit is rotatably connected to the vehicle body and a distal portion of the door drive unit is rotatably connected to the main link.

5. The door support device according to claim 1, wherein,
when a position of the door when the door opening is fully closed is defined as a fully closed position and a position of the door when the door opening is fully opened is defined as a fully open position,
the adjusting mechanism causes the distance to be shorter as an opening degree of the door is larger when the door is displaced from the fully closed position toward the fully open position.

6. The door support device according to claim 2, wherein,
when a position of the door when the door opening is fully closed is defined as a fully closed position and a position of the door when the door opening is fully opened is defined as a fully open position,
the adjusting mechanism causes the distance to be shorter as an opening degree of the door is larger when the door is displaced from the fully closed position toward the fully open position.
